(19) United States
(12) Patent Application Publication
(10) Pub. No.: US 2005/0045714 A1
(43) Pub. Date: Mar. 3, 2005

(54) Financial model for coin and currency redemption at a store

(76) Inventor: Maria G. Hermanussen, San Francisco, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/932,605

(22) Filed: Sep. 2, 2004

Related U.S. Application Data
(60) Provisional application No. 60/499,508, filed on Sep. 2, 2003.

(51) Int. Cl. G06F 17/60

(52) U.S. Cl. 235/379

(57) ABSTRACT

A financial model for coin redemption where a coin redemption machine returns a financial instrument for at least 100% of the value of the coins or currency inserted for use in purchases.

### CROSS REFERENCE TO RELATED APPLICATION

The present application claims priority to U.S. Provisional Patent Application Ser. No. 60/499,508, filed Sep. 2, 2003, which application is incorporated by reference herein in its entirety.

### BACKGROUND OF THE INVENTION

1. Field of the Invention

The present invention relates to a financial model for self-service coin redemption, and in particular to a financial model for coin redemption where a coin redemption machine returns a financial instrument for at least 100% of the value of the coins or currency inserted for use in the purchase of merchandise solely within the host retailer's place of business.

2. Description of the Related Art

Over time, people tend to accumulate coin change from paper currency, and most households have one or more dishes, jars, containers and/or piggy banks filled with coins. Due to the inconvenience of redeeming the coins for their paper equivalent, these coins tend to pile up and go unused. The coins could be brought to a bank for full redemption, but banks require that the coins be sorted and wrapped into coin wrappers of fixed denominations. Moreover, banks often require that the individual have an account at the bank before accepting coins for redemption. These factors, together with the limited hours of operation and locations of banks, make this method of redemption inconvenient.

Self-service coin sorting and counting machines have been developed as an alternative to coin redemption from a bank. These machines receive coins of any denomination, tally the amount of the inserted coins, and dispense paper money or a voucher for use anywhere for the amount of the coins minus a surcharge for use of the machine. In some instances, the machines further provide coupons for merchandise. These machines are located in convenience stores and supermarkets with numerous locations and long hours of operation. Moreover, as opposed to making a special trip for coin redemption, individuals generally make use of coin redemption machines when making a trip to the store to shop for other items. A coin sorting machine as discussed above is disclosed in U.S. Pat. No. 5,620,079, entitled “Coin Counter/Sorter and Coupon/Voucher Dispensing Machine and Method,” and assigned to Coinstar, Inc. of Bellevue, Wash. This patent is incorporated by reference herein in its entirety.

As indicated above, while offering great convenience, coin sorting machines conventionally charge a fee to the user of the machine in the form of returning a smaller dollar amount than the total amount of the coins inserted. Typically, this fee may be about 7% of the coins inserted. The fee, or at least a portion of the fee, goes to the store in which the machines are located, i.e., the host store, as incentive to include the machines in the store. Other than a share of the profits made by the machine, the host store has little or no incentive to have the machine in the store. In particular, conventional financial models for coin sorting machines may not provide merchandise revenue generation for the host store.

### SUMMARY OF THE INVENTION

Embodiments of the present invention relates to a financial model for coin redemption where a coin redemption machine returns a financial instrument for at least 100% of the value of the coins or currency inserted for use in the host retailer's place of business. The financial model of coin redemption according to the present invention provides incentive for individuals to use the coin machines in that the present model returns 100% of the value of the coins inserted to the user. The financial model of coin redemption according to the present invention further provides incentive for the host stores to house the coin sorting machines in that 100% of the monetary value dispensed by the machines will come back to the host store in the form of sale of store merchandise.

The value generated at a host store from the use of a machine within the store may be printed or stored on a tangible financial instrument, such as a piece of paper or a plastic card which is presented at checkout. Alternatively, value generated at a host store from the use of a machine within the store may be stored on account which may be accessed at checkout.

### BRIEF DESCRIPTION OF THE DRAWINGS

The present invention will now be described with reference to the drawings in which:

FIG. 1 is a schematic representation of the financial model for coin redemption according to the present invention; and

FIG. 2 is a schematic representation of the financial model for coin redemption according to an alternative embodiment of the present invention.

### DETAILED DESCRIPTION

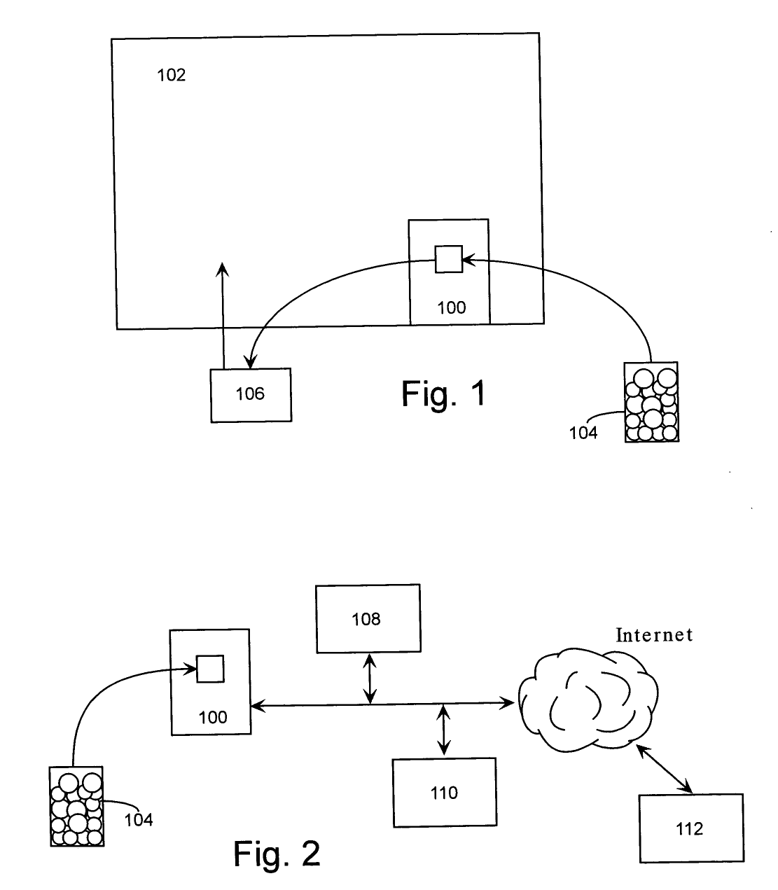

The present invention will now be described with reference to FIGS. 1 and 2, which in preferred embodiments relate to financial model for redeeming coins and currency using self-service coin sorting machines. As used herein, the term “money” refers to coins and/or paper currency. In accordance with embodiments of the invention, a coin sorting machine returns a financial instrument for 100% of the value of the coins or currency inserted for use in the host retailer's place of business. It is understood that the present invention may be embodied in many different forms and should not be construed as being limited to the embodiments set forth herein; rather these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

In one embodiment of the present invention shown in FIG. 1, a coin sorting machine 100 is located in a host store 102. It is understood that a wide variety of known coin machines may be used as machine 100. One example is the coin counting and sorting machine disclosed in U.S. Pat. No. 5,620,079, entitled “Coin Counter/Sorter and Coupon/Voucher Dispensing Machine and Method,” previously incorporated by reference. Similarly, it is understood that the host store 102 may be any of various stores including but not limited to convenience stores, supermarkets, grocery stores, hardware stores, apparel stores, toy stores, furniture stores, sporting goods stores, office supply stores and a variety of other retail stores. A host store 102 as used herein is a store in which a machine 100 is located.

In accordance with the financial model of the present invention, a user of machine 100 inserts coins 104 as conventionally done with such machines. The machine conventionally sorts and tallies the amount of the inserted coins. In embodiments of the present invention, the machine then issues a financial instrument 106 for 100% of the value of the coins 104 inserted. As used herein, financial instrument 106 refers to a document, card or other tangible medium having monetary value within the host store 102. The financial instrument 106 may only be used within the host store.

The financial model of coin redemption according to the present invention provides greater incentive for individuals to use the coin machines relative to conventional financial models for such machines in that the present model returns 100% of the value of the coins inserted to the user. This is an improvement over conventional financial models for such machines, which extract a fee from the user for use of the machine. The financial model of coin redemption according to the present invention further provides incentive for the host stores to house the coin sorting machines in that 100% of the monetary value dispensed by the machines will come back to the host store in the form of sale of store merchandise. This is an improvement over conventional financial models for such machines, which issue instruments which can be used anywhere and do not necessarily result in sale of merchandise from the host store. The host store may own the machine 100. Alternatively, the host store may pay a fee to the owner of the machine for its use within the store.

The financial instrument 106 may be a bearer instrument usable in the host store by any individual, regardless of whom it was originally issued to. Alternatively, the user of the machine 100 may be able to input identification information into the machine at the time the coins 104 are inserted, so that the financial instrument 106 will have identification information printed thereon, and may only be used by the individual to whom the instrument was issued. This identification information may include one or more of a person's name, address, date of birth, social security number and/or a shopper identification number assigned by the store. The instrument 106 may additionally or alternatively include a photo of the owner of the instrument. To the extent conventional coin sorting machines are not presently configured to accept user identification information, those of skill in the art would readily understand how to modify conventional coin sorting machines to accept user information.

Financial instrument 106 may be a tangible medium such as a piece of paper, cardboard or plastic with the monetary value printed thereon, along with the identification information in embodiments utilizing identification information. The information may be included in alphanumeric characters and/or in code, such as a bar code. The instrument 106 may also include authentication information in the form of a code and/or insignia. In this instance, the insignia may be something which is not easily copied, and the code may be something, such as a bar code, which can be checked to ensure the instrument was not previously used to purchase merchandise.

Where the information is printed on the instrument, the checkout clerk in the host store can visually inspect the instrument when it is used to purchase merchandise to determine the value of the instrument and, in certain embodiments, the identification information (the bearer can be asked for identification to confirm matching identity). Additionally, at that time, the checkout clerk can verify that the instrument is authentic by the code and/or insignia. As is known in the art, various scanners, such as bar code scanners, may be used instead of or in addition to the visual inspection by the checkout clerk to aid in the determination of the instrument value, the instrument identification information and/or the authentication information.

The checkout clerk would then cause the value in the instrument to be reduced by the total price of the merchandise purchased (merchandise price plus applicable taxes), up to the value on the instrument. While the instrument has been described as being used for merchandise, it is understood that the instrument may be used for any purchase, including merchandise, services and warranties provided by or through the host store.

When the financial instrument 106 is used to purchase merchandise for less than the entire value of the instrument 106, the checkout clerk can issue a new instrument showing the new value of the instrument after the purchases. If the value of the items purchased exceeds the amount of value in the instrument, then the remainder can be paid in currency or by some other method of payment.

As an alternative to a visual indication of the above-described information, the financial instrument 106 may be capable of storing digital information on a memory strip provided on the instrument. Storage of such information on a memory strip provided on a tangible medium is well known and may be accomplished for example by magnetically or optically encoding the memory strip. Owing to its durability, typically an encoded instrument 106 will be formed of plastic, but paper and cardboard instruments may similarly be encoded. To the extent conventional coin sorting machines are not presently configured to accept and digitally record information onto a tangible medium, those of skill in the art would readily understand how to modify conventional coin sorting machines to perform such actions.

In this embodiment, instrument value, user identification information and authentication information may all be encoded onto the memory strip. It is understood that the memory strip may include additional information, such as for example purchasing history and frequency of use, as well as the purchasing patterns and type of merchandise purchased with the financial instrument 106. In embodiments of the present invention utilizing an instrument 106 including a digital memory, the instrument may or may not have a visual representation of the information (value, identification and/or authentication) stored on the card.

Where the information is digitally encoded on the instrument, the checkout clerk in the host store can use conventional digital scanners or readers when the instrument is used to purchase merchandise to determine the value of the instrument, the identification information and the authentication information. Where less than the entire value of the instrument is used to purchase merchandise, the new value after purchases may be encoded onto the instrument at checkout.

Owing to the convenience of an encoded instrument 106 for use in a host store, it is understood that currency in addition to or instead of only coins may be used when generating the instrument 106. Namely, paper currency may be inserted into machine 100 to produce instrument 106 of any given value, and the instrument thereafter used to purchase merchandise in the host store as described above. To the extent conventional coin sorting machines are not presently configured to accept paper currency, those of skill in the art would readily understand how to modify conventional coin sorting machines to perform such actions. Paper currency may also be used to generate financial instrument 106 where the information is visually printed (instead of digitally encoded) on the instrument in alternative embodiments.

It is also contemplated that an issued instrument 106 be inserted into a machine 100 for the purpose of adding value to the instrument by inserting additional coins or paper currency. Once the currency has been inserted into the machine 100, a new instrument may be issued, or the old instrument may be issued with the new value printed or encoded thereon. To the extent conventional coin sorting machines are not presently configured to add value to an existing instrument, those of skill in the art would readily understand how to modify conventional coin sorting machines to perform such actions.

Up to this point, the present invention has been described as issuing a tangible instrument 106 having the value of the currency inserted into the machine 100. However, in an alternative embodiment shown in FIG. 2, it is understood that the financial model of the present invention may be implemented without issuing an instrument 106. In accordance with this embodiment, coins and/or paper currency are inserted into a machine 100 in a host store 102 as described above. However, instead of issuing a tangible instrument 106, the value inserted and the identification information provided are stored on a server 108 provided as part of a local area network (LAN) or a wide area network (WAN) of which the machine 100 is part. In this embodiment, the server 108 may be located within or remote from the host store 102.

In accordance with this embodiment, a user opens an account with the account information stored on server 108. In embodiments of the invention, the account is administered by the host store, but it is understood that an independent entity may be set up to administer the accounts for one or more host stores. In this event, the account would also have an indication of the host store at which credit has been generated. The account information may include the monetary value input, user identification information, purchasing patterns, purchasing history, frequency of use, as well as the type of merchandise purchased. In addition, the user may create a user ID and a password stored on server 108 to ensure privacy and security for the account.

As further shown in FIG. 2, a personal computer (PC) 110 or other device including a processor and a link to the server 108 may be provided at the merchandise checkout location. Once an account is created, a user may purchase items at the host store by simply logging into his or her account at the checkout location and the value of the items purchased is automatically deducted from the account. The value in the account may be used for any purchase at the host store, including merchandise, services and warranties provided by or through the host store.

It is further contemplated that a financial instrument 106 or other card having user ID digitally encoded thereon may be provided in conjunction with this embodiment. The card may be used together with a password to access a user's account (at a checkout location or otherwise). The card described here may differ from the financial instrument 106 disclosed in association with FIG. 1 in that the card need not include stored value or other information, as the card is used merely to gain access to one's account, where the information is stored.

In accordance with the embodiment shown in FIG. 2, in addition to accessing an account via a machine 100 or via the PC 110 at checkout, a user may access his or her account over the Internet via a remote PC 112. PC may be a home computer or otherwise. If a user has credit in his or her account, the user may order items from the host store from the remote PC 112, for pickup or delivery to a remote location such as the user's home.

In accordance with the embodiment of FIG. 2, a user may deposit coins or other currency into a machine in a host store to obtain an account and credit at the host store, which account may be viewed at the host store or over a remote PC.

It is understood that an individual may have a single account covering multiple host stores where the user has generated credit from use of a machine 100 thereat. Alternatively, the user may have multiple accounts, one for each host store. Moreover, in embodiments of the present invention, it is further contemplated that a single financial instrument 106 may have value which has been generated at multiple host stores from use of the single instrument 106 at machines 100 in the multiple host stores. In this embodiment, the instrument must further include information for distinguishing between the various host stores, so that when the instrument is used at a particular host store, the value added or subtracted from the instrument occurs specifically with respect to that host store.

In the embodiments of either FIG. 1 or FIG. 2, as an added incentive to use the machine 100, a host store may set up a machine 100 to generate value on a financial instrument 106 or in one's account in an amount in excess of the amount of coin or currency fed into machine 100. In one embodiment, the excess amount may be equal to 10% of the value of the currency inserted into the machine 100. It is understood that the excess amount may be greater than or less than 10% in alternative embodiments. The excess amount may be applied to any merchandise storewide in the host store. Alternatively, stored information regarding the user's buying patterns and history may be used to give additional value useable specifically on the merchandise most frequently purchased by the user, or other merchandise compatible with the user's buying habits.

It is understood that a host store may not be limited to the specific store in which a machine 100 is located, but may also encompass other stores similarly under the ownership of the host store. Thus for example, a user may receive a financial instrument 100 in an Albertsons supermarket at a first location, which may then be used at an Albertsons supermarket at a second location. Moreover, it is understood that a parent company may own a number of different retail stores, and further that partnerships may be formed between differently owned stores. For these possibilities, in a further embodiment, value may be generated on an instrument 106 or on account from the use of a machine 100 in a host store, which value may then be spent both at the host store and at other host-designated stores.

While the machine 100 has been described above as a self-service machine, it is understood that insertion of coins and/or the entry of information into the machine 100, where applicable, could be handled by personnel of the host store.

Although the invention has been described in detail herein, it should be understood that the invention is not limited to the embodiments herein disclosed. Various changes, substitutions and modifications may be made thereto by those skilled in the art without departing from the spirit or scope of the invention as described and defined by the appended claims.

1. A financial model for redemption of currency from a coin redemption machine within a host store, comprising the steps of:
(a) inserting currency into the machine;
(b) tallying the amount of the currency inserted in said step (a);
(c) returning a financial instrument for the full amount of currency inserted in said step (a), the financial instrument being redeemable for one or more purchases only in the host store.

2. A financial model for redemption of currency from a coin redemption machine within a host store as recited in claim 1, further comprising a step (d) of entering information into the machine which appears on the financial instrument.

3. A financial model for redemption of currency from a coin redemption machine within a host store as recited in claim 1, further comprising a step (d) of entering information into the machine which is encoded on the financial instrument.

4. A financial model for redemption of currency from a coin redemption machine within a host store as recited in claim 1, wherein said step (a) of inserting currency into the machine comprises the step of inserting only coins.

5. A financial model for redemption of currency from a coin redemption machine within a host store as recited in claim 1, wherein said step (a) of inserting currency into the machine comprises the step of inserting coins or paper currency.

6. A financial model for redemption of currency from a coin redemption machine within a host store as recited in claim 1, further comprising the steps of:
(e) presenting the financial instrument at checkout to pay for the one or more purchases at the host store; and
(f) reducing a value of the instrument in an amount equal to the total price of the one or more purchases, said reduction not to exceed the value in the instrument prior to said step (e) of presenting the instrument.

7. A financial model for redemption of currency from a coin redemption machine within a host store as recited in claim 1, further comprising the steps of:
(g) reinserting a financial instrument into the machine;
(h) inserting additional currency into the machine; and
(i) returning a financial instrument for the sum of the full amount of the value in the instrument prior to said step (g) of reinsertion and the full amount of currency inserted in said step (h) of inserting additional currency.

8. A financial model for redemption of currency from a coin redemption machine within a host store, comprising the steps of:
(a) inserting currency into the machine;
(b) tallying the amount of the currency inserted in said step (a);
(c) entering account information to create or access an account including credit equal to the full amount of currency inserted into the machine in said step (a), the credit being redeemable for one or more purchases solely at the host store.

9. A financial model for redemption of currency from a coin redemption machine within a host store as recited in claim 8, further comprising the steps of:
(d) accessing the account created in said step (c) at checkout to pay for the one or more purchases at the host store; and
(e) reducing the credit in the account in an amount equal to the total price of the one or more purchases, said reduction not to exceed the credit in the account prior to said step (e) of presenting the instrument.

10. A financial model for redemption of currency from a coin redemption machine within a host store as recited in claim 8, said step (c) of entering account information to create an account includes a step (f) of storing the account information on a server located within the host store or remote from the host store.

11. A financial model for redemption of currency from a coin redemption machine within a host store as recited in claim 8, further comprising a step (g) of accessing the account from a location remote from the host store by entering a user ID and password.

12. A financial model for redemption of currency from a coin redemption machine within a host store, comprising the steps of:
(a) inserting currency into the machine;
(b) tallying the amount of the currency inserted in said step (a);
(c) returning a financial instrument for an amount greater than the full amount of currency inserted in said step (a), the credit being redeemable for one or more purchases only in the host store.

13. A financial model for redemption of currency from a coin redemption machine within a host store as recited in claim 12, further comprising a step (d) of monitoring a purchasing history and/or purchasing pattern for purchases at the host store, the credit in excess of the amount inserted in said step (a) being redeemable only for one or more purchases identified in said step (d) of monitoring a purchasing history and/or purchasing pattern.

14. A financial model for redemption of currency from a coin redemption machine within a host store as recited in claim 12, further comprising a step (d) of monitoring a purchasing history and/or purchasing pattern for purchases at the host store, the credit in excess of the amount inserted in said step (a) being redeemable only for one or more purchases compatible with the one or more purchases identified in said step (d) of monitoring a purchasing history and/or purchasing pattern.

15. A financial model for redemption of currency from a coin redemption machine within a host store as recited in claim 12, the credit in excess of the amount inserted in said step (a) being redeemable only for one or more purchases selected by the host store.

16. A financial model for redemption of coins from a coin redemption machine, comprising the steps of:
(a) inserting coins into the machine, the machine being located at a first store;
(b) tallying the amount of the coins inserted in said step (a);
(c) returning a financial instrument for at least the full amount of coins inserted in said step (a), the financial instrument being redeemable for one or more purchases at a second store.

17. A financial model for redemption of coins from a coin redemption machine as recited in claim 16, wherein said step (c) of returning the financial instrument comprises the step of issuing a card having the value of the coins inserted in said step (a) encoded thereon.

18. A financial model for redemption of coins from a coin redemption machine as recited in claim 16, further comprising the steps of:
(d) reinserting the financial instrument at least partially into the machine in the first store;
(e) inserting additional coins into the machine; and
(f) returning the financial instrument for the sum of the full amount of the value in the instrument prior to said step (d) of reinsertion and at least the full value of coins inserted in said step (e) of inserting additional coins.

19. A financial model for redemption of coins from a coin redemption machine as recited in claim 16, further comprising the steps of:
(d) inserting the financial instrument at least partially into a second coin redemption machine, the second coin redemption machine being located at a third store;
(e) inserting coins into the second coin redemption machine; and
(f) returning the financial instrument for the sum of the full amount of the value in the instrument prior to said step (d) of reinsertion and the full amount of the coins inserted in said step (e) of inserting additional coins.

20. A financial model for redemption of coins from a coin redemption machine as recited in claim 16, wherein said first and second stores are commonly owned.

21. A financial model for redemption of coins from a coin redemption machine as recited in claim 16, wherein said first and second stores are not commonly owned.

22. A financial model for redemption of coins from a coin redemption machine as recited in claim 16, wherein the financial instrument is good only for particular purchases in the second store.

23. A financial model for redemption of coins from a coin redemption machine, comprising the steps of:
(a) inserting coins into the machine, the machine being at a first location;
(b) tallying the amount of the coins inserted in said step (a);
(c) returning a financial instrument for at least the full amount of coins inserted in said step (a), the financial instrument being redeemable for one or more purchases at a second location.

24. A financial model for redemption of coins from a coin redemption machine as recited in claim 23, wherein said step (c) of returning the financial instrument comprises the step of issuing a card having the value of the coins inserted in said step (a) encoded thereon.

25. A financial model for redemption of coins from a coin redemption machine as recited in claim 23, further comprising the steps of:
(d) reinserting the financial instrument at least partially into the machine in the first location;
(e) inserting additional coins into the machine; and
(f) returning the financial instrument for the sum of the full amount of the value in the instrument prior to said step (d) of reinsertion and at least the full value of coins inserted in said step (e) of inserting additional coins.

26. A financial model for redemption of coins from a coin redemption machine as recited in claim 23, further comprising the steps of:
(d) inserting the financial instrument at least partially into a second coin redemption machine, the second machine being at a third location;
(e) inserting coins into the second machine; and
(f) returning the financial instrument for the sum of the full amount of the value in the instrument prior to said step (d) of reinsertion and the full amount of the coins inserted in said step (e) of inserting additional coins.

27. A financial model for redemption of coins from a coin redemption machine as recited in claim 23, wherein said first and second locations are places of business that are commonly owned.

28. A financial model for redemption of coins from a coin redemption machine as recited in claim 23, wherein said first and second locations are places of business that are not commonly owned.

29. A financial model for redemption of coins from a coin redemption machine as recited in claim 23, wherein the financial instrument is good only for particular purchases in the second location.

30. A financial model for redemption of coins from one or more coin redemption machines, comprising the steps of:
(a) inserting coins into the machine, the machine being located at a first store;
(b) tallying the amount of the coins inserted in said step (a);
(c) returning a card having a value digitally encoded on the card equal to at least the full value of the coins tallied in said step (b), and any previous value digitally encoded on the card; and
(d) redeeming the value digitally encoded on the card for one or more purchases at a second store.

31. A financial model for redemption of coins from a coin redemption machine as recited in claim 30, wherein said first and second stores are commonly owned.

32. A financial model for redemption of coins from a coin redemption machine as recited in claim 30, wherein said first and second stores are not commonly owned.

33. A financial model for redemption of coins from one or more coin redemption machines, comprising the steps of:
(a) inserting coins into a first coin redemption machine, the first coin redemption machine being located at a first store;
(b) tallying the amount of the coins inserted in said step (a);
(c) issuing a card having the full amount of the coins tallied in said step (b) digitally encoded thereon, the card being redeemable for one or more purchases at a second store; and
(d) allowing the amount digitally encoded on the card to be incremented by the steps of:
(i) inserting the card at least partially into at least one of: 1) the first coin redemption machine at the first store, and 2) a second machine at a third store,
(ii) inserting coins into at least one of the first coin redemption machine and the second machine, and
(iii) returning the card having a value digitally encoded thereon equal to the sum of the full amount encoded on the card prior to said step (i) of inserting the card into at least one of the first and second machines, and the full amount of coins inserted in said step (ii) of inserting coins in at least one of the first and second machines.

34. A financial model for redemption of coins from a coin redemption machine as recited in claim 33, wherein said first and second stores are commonly owned.

35. A financial model for redemption of coins from a coin redemption machine as recited in claim 33, wherein said first and second stores are not commonly owned.

36. A financial model for redemption of coins from a coin redemption machine as recited in claim 33, wherein the second machine is a second coin redemption machine.

37. A machine for allowing redemption of coins, the machine comprising:
an input for allowing a number of coins to be input into the machine;
a tally mechanism for tallying the value of the number of coins input into the machine;
a computing device for digitally encoding a card with at least the full value of the number of coins input into the machine; and
a dispensing mechanism for issuing the card from the machine.

38. A machine for allowing redemption of coins, the machine comprising:
an input for allowing a number of coins to be input into the machine;
a tally mechanism for tallying the value of the number of coins input into the machine;
a card receiver for at least partially receiving a card capable of digitally storing a value of the coins input to the machine; and
a computing device for: 1) reading the value stored on the card, and 2) incrementing the value stored on the card by an amount equal to at least the full value of the number of coins input into the machine.
